(19) United States
(12) Patent Application Publication
(10) Pub. No.: US 2008/0098081 A1
(43) Pub. Date: Apr. 24, 2008

(54) MOVING IMAGE DISPLAYING METHOD AND SYSTEM

(76) Inventors: Fumio NODA, Kodaira (JP); Masahiko Takeshima, Higashiyamato (JP); Osamu Ishihara, Ebina (JP); Yutaka Tokue, Yokohama (JP); Hiroshi Mine, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/927,958

(22) Filed: Oct. 30, 2007

Related U.S. Application Data
(63) Continuation of application No. 11/688,906, filed on Mar. 21, 2007.

(30) Foreign Application Priority Data
Sep. 26, 2005 (JP) 2005-277050

(51) Int. Cl. G06F 15/16

(52) U.S. Cl. 709/208

(57) ABSTRACT

A moving image displaying method to be executed in a network computer system having an operating-side computer and an operated-side computer coupled through a network, the operating-side computer coupling with the operated-side computer for performing input operation to the operated-side computer, and an operation result view appearing on the operated-side computer being displayed on a display unit of the operating-side computer, including the steps of: capturing, by the operated-side computer, event information inputted by the operating-side computer, the event information being information about a playback operation of a moving image; transmitting, by the operated-side computer, control information about playback of the moving image on the operated-side computer to the operating-side computer, based on the event information; receiving, by the operating-side computer, moving image data to be playback-controlled by the received control information about playback of the moving image; playing back, by the operating-side computer, a moving image to be displayed from the received moving image data, based on the control information; and overlapping, by the operating-side computer, the playback moving image on the operation result view to display the overlapped result on the display unit of the operating-side computer.

### CROSS REFERENCE TO RELATED APPLICATION

This is a continuation of U.S. application Ser. No. 11/688,906, filed Mar. 21, 2007. This application relates to and claims priority from Japanese Patent Application No. 2005-277050, filed on Sep. 26, 2005. The entirety of the contents and subject matter of all of the above is incorporated herein by reference.

### BACKGROUND OF THE INVENTION

The present invention relates to a technology of transferring display information among computers which technology is configured to transfer information about remote operation through a network.

In a network computer system having a plurality of personal computers coupled through a network, a remote operating technology is put into practice use. This remote operating technology is configured to couple an operating side computer (referred to as a user computer) to another operated-side computer (referred to as a host computer) so that the user computer may remotely operate the host computer. In the remote operation, the contents to be inputted in the operating-side computer with a keyboard and a mouse are transmitted to the host computer so that the host computer may execute information processing according to the input operation. The output view contents of the host computer are transmitted from the host computer to the operating-side computer and then the view contents are displayed as a remote operation view on a display device of the operating side computer.

In general, since the data amount of the output view contents are more massive than the data amount to be inputted by an operation, in the conventional remote operation, the compressive encoding is carried out so that the remote operation view may be efficiently transferred in a limited network band (refer to the pamphlet of WO 2001/092973). In addition, for enhancing privacy of a network such as the Internet to be used by many and unspecified persons, the technology about encryption of data to be transferred and the virtual private network (VPN) is also being used.

### SUMMARY OF THE INVENTION

In the prior art, when a moving image, usually referred to as a video, and a streaming delivered image (totally referred simply to as a moving image) to be play backed and processed in the host computer by the remote operation is transmitted to and displayed at the operating-side computer, the data having being transmitted by the host computer is not processed timely by the operating-side computer because of the adverse influence of variation of a transmitted data amount and bandwidth variation. Hence, for example, the motion of the display image is stopped and a part of the image is cut away, so that the smooth moving picture cannot be displayed as it is.

That is, the host computer performs a proper decoding process with respect to the moving data encoded on the standard moving picture compressing algorithm by the remote operation and then a playback process so that the moving image may keep its display speed stable. However, the playback image is again compressive-encoded for the remote operation by the host computer and then transferred to the operating-side computer through the effect of a transferring process through the network. The playback image is processed on the display screen of the operating-side computer. Hence, the disadvantageous delay and fluctuation of these processes are made so large that the moving image display at the operating-side computer is made less stable.

When the data is encrypted or the VPN or the like is used on the Internet, the foregoing disadvantages are made more serious. That is, the addition of encryption, encapsulation of communication packets and VPN processing like tunneling does not necessarily synchronize the timing of the moving image transmission by the host computer with the timing of the screen display processing by the operating-side computer. Further, the packetizing in the network often brings about the new disadvantages of packet loss and packet retransmission.

The present invention provides a moving image transmitting and displaying method to overcome the foregoing disadvantages brought about when the moving image is transmitted from a computer to be remotely operated to the operating-side computer through the network. The method provided by the present invention enables stable display of the moving image at the operating-side computer included in a network computer

The present invention provides a function of performing the moving image transmitting and displaying process in cooperating the operated-side computer with the operating-side computer when playing back the moving image at the operating-side computer and a function of controlling playback of the moving image so that the moving image may be exactly displayed on the display screen of the operating-side computer.

According to an aspect of the present invention, in a network computer system having an operating-side computer and a operated-side computer, both of the computers being coupled through a network, so that the operating-side computer operates the input to the operated-side computer and the operation view of the operated-side computer is displayed on a display device of the operating-side computer, the moving image transmitting and displaying method includes the steps of capturing event information about playback of a moving image to be inputted in the operating-side computer by the operated-side computer, transmitting to the operating-side computer control information about playback of the moving image on the operated-side computer, receiving on the operating-side computer the moving image data to be playback-controlled by the control information about the playback of the received moving image, playing back the moving image to be displayed from the received moving image data on the basis of the control information, and overlapping the operation view to be displayed on the display device with the playback moving image and displaying the overlapped image.

The moving image displaying method according to an aspect of the invention may include an additional step of determining if the event information captured by the operated-side computer is an event about playback of a moving image stored in the operated-side computer or an event about playback of a moving image coming from another computer. Further, in a case that the event information captured by the operated-side computer is determined to be the event about playback of the moving image from the stored moving image file, the moving image displaying method may include an additional step of transmitting the moving image data played back from the stored moving image file to the operating-side computer and receiving on the operating-side computer the moving image data from the operated-side computer.

The moving image displaying method according to an aspect of the invention may include an additional step of causing the operating-side computer to transmit the timing information in playing back the moving image data to the operated-side computer and an additional step of causing the operated-side computer to arrange a transmission speed of the moving image data based on the received timing information so that the operating-side computer plays back the moving image from the corresponding moving image data at a faster speed than the speed at which the moving image is to be displayed.

The moving image displaying method according to an aspect of the invention may include an additional step of causing the operated-side computer to transmit to another computer a request for obtaining the moving image data to be played back on the event information in a case that the captured event information is determined to the event in which the moving image data is received and played back from another computer and an additional step of receiving on the operating-side computer the moving image data from another computer. More particularly, the moving image displaying method may also include an additional step of causing the operating-side computer to transmit to another computer a request for obtaining the moving image data played back on the event information and an additional step of receiving the moving image data from another computer without through the operated-side computer.

The moving image displaying method according to an aspect of the invention may include an additional step of causing the operated-side computer to define a display area of the moving image based on the event information being inputted in the operating-side computer, an additional step of including the defined display area information in the control information to be transmitted to the operating-side computer, and an additional step of causing the operating-side computer to define a display area of the moving image to be overlapped on the operation view according to the control information and overlap the moving image. Or, the operating-side computer may be caused to define the display area of the moving image on the basis of the inputted event information.

The moving image displaying method according to an aspect of the invention may include an additional step of causing the operated-side computer to select if the moving image data is straightforward made to be the encoded data read from the moving image file or another type of moving image data created from the encoded data. Further, this selection may be carried out in the operated-side computer on the basis of the event information to be inputted by the operator in the operating-side computer.

According to the foregoing aspect of the invention, the host computer to be remotely operated is cooperated with the operating-side computer for performing the process of transferring and displaying the moving image. Hence, the resulting moving image display may keep its display speed constant and its motion smooth on the display screen of the operating-side computer.

Further, since the distributed computers are cooperated with one another, for performing the process of transmitting the moving image, it is advantageous to effectively use computer resources.

The moving image transmitting and displaying method according to an aspect of the invention may be used in a system of delivering the moving image contents, a system of using a moving image bi-directionally, Video conferencing, or the like.

According to the invention, in the case that the operating-side computer remotely operates the target computer (to be operated) through a network, on the display screen of the operating-side computer, the moving image may be displayed at a display speed arranged according to an operator's intention.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a block diagram showing a network computer system according to a first embodiment of the invention.

FIG. 2 is a flowchart showing a flow of a process for a moving image playback event included in the first embodiment.

FIG. 3 is a flowchart showing a flow of a moving image data transfer process included in the first embodiment.

FIG. 4 is a flowchart showing a flow of a moving data receiving, playback and displaying process included in the first embodiment.

FIGS. 5A and 5B illustrate an output host view appearing in the first embodiment.

FIGS. 6A and 6B illustrate an output moving image playback view appearing in the first embodiment.

FIG. 7 shows a transfer sequence executed in a moving image transfer process included in the first embodiment.

FIG. 8 is a block diagram showing a network computer system that implements the moving image transfer and display method according to a second embodiment of the invention.

FIG. 9 is a flowchart showing a flow of a moving image transfer and display process included in the second embodiment.

FIG. 10 is a block diagram showing a network computer system according to a third embodiment of the invention.

### DETAILED DESCRIPTION OF THE EMBODIMENTS

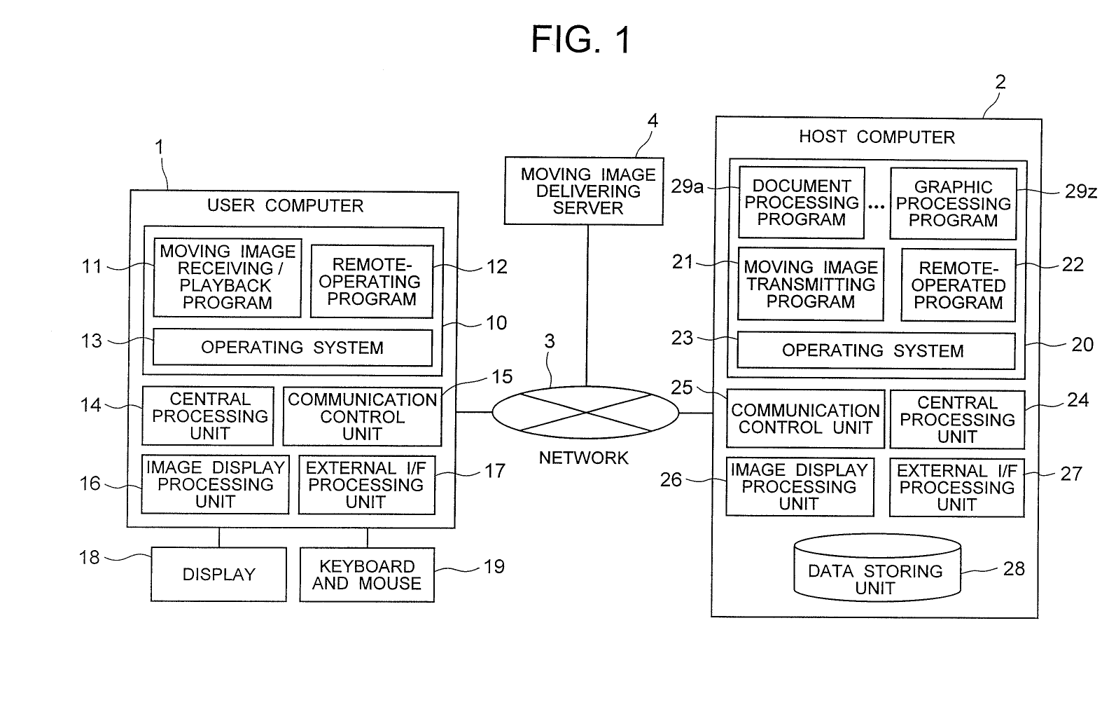

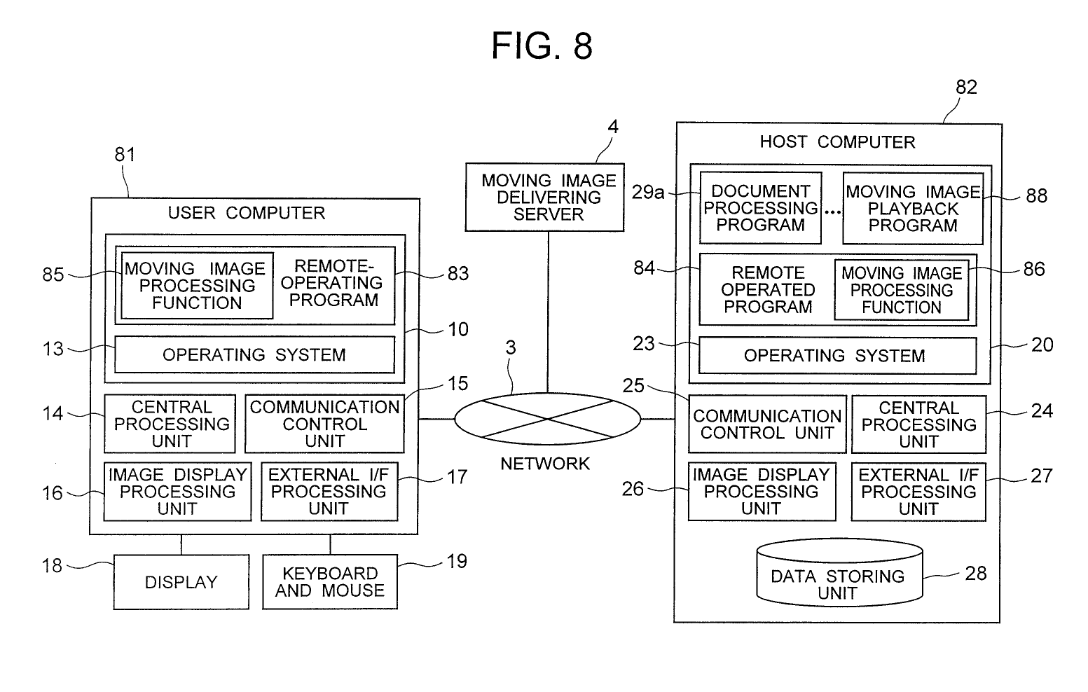

One embodiment of the present invention will be described with reference to FIGS. 1 to 7. Another embodiment of the present invention will be described with reference to FIGS. 8 to 9 and 10.

FIG. 1 shows a configuration of a network computer system according to an embodiment of the moving image displaying method of the invention. This system is configured to have a plurality of computers such as personal computers coupled through a network 3 composed of the Internet and the like.

FIG. 1 shows a user computer 1 located on the operating side and a host computer 2 to be operated one by one for the sake of explanation's convenience. Further, just one moving image delivering server unit 4 (referred to as the moving image delivering server), which delivers the encoded moving image data and the like in a streaming manner, is shown as well. In actual, a plurality of servers 4 may be distributed on the network 3.

The user computer 1 includes a memory 10, a central processing unit 14, a communication control unit 15, an image display unit 16, an external interface (I/F) processing unit 17, and the like in itself. Further, as the external connecting devices, the user computer 1 is also equipped with an output device such as a display unit (totally referred to as a display) 18, an input device 19 such as a keyboard and a mouse (totally referred to as a keyboard and mouse). Those components are coupled inside the computer through buses and the like (not shown) so that information may be conveyed among those components. The detailed description about the ordinary operation of the user computer 1 is left out.

The memory 10 stores an operating system (abbreviated as an OS) 13 to be executed by the central processing unit 14, a moving image receiving and playing back program 11, and a program 12 that remotely operates a program loaded in the host computer (simply referred to as a remote operating program), the latter two of which are the application program to be run on the OS 13.

The host computer 2 includes a memory 20, a central processing unit 24, a communication control unit 25, an image display unit 26, an external I/F processing unit 27, a data storing unit 28 such as a hard disk, and the like.

Though not shown, like the user computer 1, the display and the keyboard and mouse may be provided as external connecting devices. Also like the user computer 1, those components are coupled inside the host computer 2 through buses and the like so that information may be conveyed among those components.

The memory 20 stores an OS 23 to be executed by the central processing unit 24, a moving image transmitting program 21, a program 22 to be remotely operated by the remote operating program loaded in the user computer 1 (simply referred to as a remote operated program), a document processing program 29a, a graphic processing program 29z, and the like, the programs except the OS 23 being the application programs to be run on the OS 23.

Moreover, the memories 10 and 20 are each composed of a volatile memory in which the storage contents are lost when the power supply is stopped. When the computer is turned on, the OS and the relevant programs are loaded in these memories 10 and 20 from a nonvolatile memory (not shown) and the data storing unit 28.

In a specific embodiment, a computer like a leased terminal may be provided which is arranged to have a nonvolatile memory so that the OS and the relevant programs may be run in the nonvolatile memory.

The following embodiments do not depend upon the kinds and the ways of use of the computers and may include as the memories the volatile ones or the nonvolatile ones.

The network 3 is made up of the ordinary LAN (Local Area Network), the Internet, and the like. As the network 3, the various logical arrangements are made available and the various physical communication mediums are made available as well.

In this embodiment, the minimum requirement of the network 3 is an implementation of a remote operating communication between the user computer 1 and the host computer 2. For the purpose of enhancing privacy of the communication to be executed through the Internet and the like, it is preferable to encrypt the communication data to be transferred between the user computer 1 and the host computer 2 or use the VPN (Virtual Private Network) for the communication.

Further, what is also required for the network 3 is to deliver the communication data from the moving image delivering server 4 to the user computer 1 or the host computer 2 with low data delay and fluctuation.

Moreover, the foregoing programs may be pre-stored in the nonvolatile memory (not shown) and the data storing unit 28. Instead, those programs may be introduced from another storage medium or another device through a communication medium if necessary. The communication medium means the foregoing network 3 or a carrier or a digital signal to be conveyed on the network 3.

In this embodiment, the user computer 1 and the host computer 2 both perform the encryption when the data to be transmitted is converted into a predetermined format through the effect of the remote-operating program 12 and the remote-operated program 22. One computer receives the encrypted data from the other computer and then decodes the data when the data contents are read.

The protocol to be use for the communication is the standard one such as the PPTP (Point to Point Tunneling Protocol). Herein, the detailed description about the key exchange process and the communication protocol for cipher communications is left out. In addition, the network 3 may be arranged to have a leased VPN unit so that packets to be communicated between the user computer 1 and the host computer 2 may be encrypted. In this case, it is possible to lessen the burden of the VPN processing to be placed on the user computer 1 and the host computer 2.

The moving image delivering server 4 provides a function of delivering the moving image data encoded (compressed) by the standard moving image compressing algorithm in response to a request issued from a client (the user computer 1 or the host computer 2).

In general, the moving image delivering server 4 also provides a function of displaying to the client a title list of the moving image contents to be delivered and a function of determining the delivering condition about the contents selected by the client on the basis of the computer resources of the destination client and the communication status of the network 3. Moreover, the server 4 may provide a special function of authorizing a user, managing a copyright of the contents, and performing an accounting process.

The various kinds of the moving image compressions and delivering formats are made available. Plural kinds of programs to be executed by the client are put into practical use. In this embodiment, the kind of the moving image is not limited, so that this embodiment is applicable to various kinds of moving images.

When the user computer 1 remotely operates the host computer 2, some programs loaded in each computer are executed so that both of the computers may work in concert. That is, the remote operating program 12 is worked in concert with the remote operated program 22 for realizing the ordinary remote operating process. When playing back the moving image file and the moving image to be delivered in a streaming manner, the moving image transmitting program 21 and the moving image receiving and playing back program 11 are executed and then joined to the remote operation for displaying the moving image.

The remote-operating program 12 provides the conventional remote operating function and the function of the moving image displaying method according to one embodiment of the present invention. This program 12 realizes the following process under the control of the OS 13 and the central processing unit 14.

In the ordinary remote operation, the input operation to be executed by an operator with the keyboard and mouse 19 is captured through the external I/F processing unit 17. Then, the captured data is converted into the predetermined type of data. The converted data is transferred from the communication control unit 15 to the host computer 2 through the network 3.

The processing result of the remote operation of the host computer 2 is received as the predetermined type of output data in the user computer 1 through the communication control unit 15. The display image is generated from the predetermined type of output data in concert with the image display unit 16 and then is displayed on the screen of the display 18.

Then, the operator inputs data with the keyboard and mouse 19 and operates the application program(s) run on the host computer 2 as watching the remote operation view appearing on the display 18, so that the operator may remotely execute the intentional information processing.

In the moving image transfer display, the predetermined type of data transferred by the run of the moving image transmitting program 21 is received in the user computer 1 through the communication control unit 15 under the control of the moving image receiving and playing back program 11.

The remote-operated program 22 provides the function corresponding with the remote-operating program 12. The following process is realized under the control of the OS 23 and the central processing unit 24.

In the ordinary remote operation, the operating data transferred from the user computer 1 is received in the host computer 2 through the communication control unit 25. Then, the operating data is converted into the same control data as the operation data inputted with the keyboard and mouse coupled with the external I/F processing unit 27. The converted data is put into the control of the OS 23.

By this operation, the host computer 2 performs the information processing such as execution of the document processing program 29a and the graphic processing program 29z in response to the remote operation to be executed by the operator.

The results processed by these application programs are outputted as the drawing data for the image display unit 26 and the storage data for the data storing unit 28. Hence, the output of the drawing data is captured under the control of the remote-operated program 22 and then is compressive-encoded into the predetermined type of output data. Then, the compressed data is transmitted from the communication control unit 25 to the user computer 1 through the network 3.

In the moving image displaying operation, the predetermined type of data generated by the moving image transmitting program 21 is transmitted by the communication control unit 25 to the user computer 1 as being relayed by the moving image receiving and playing back program 11.

In this embodiment, since the image display of the host computer 2 is not essential during the execution of the remote operation, the actual processing of the image display unit 26 may be simplified. Hence, if the display unit or the like is coupled with the host computer 2, an unvaried image appears on the screen of the display. This is effective in reducing the load of the image processing to be executed by the central processing unit 24.

The moving image transmitting program 21 provides the moving image transfer function that is an implementation of the moving image display method according to the present invention. The program 21 is run under the control of the OS 23 and the central processing unit 24 and basically realizes the following process in concert with the remote-operated program 22.

When playing back the moving image from the moving image file stored in the data storing unit 28, the moving image transmitting program 21 performs the conveyance of the information about the location and the size of the moving image on the screen to the user computer 1. Further, the data of the moving image file is converted into the moving image data compressive-encoded to the predetermined type being suited to the streaming delivery without having to display the image on the display of the host computer 2 and then the compressed moving image data is transferred to the user computer 1.

Further, when the user computer 1 receives the moving image delivered from the moving image delivering server 4 in the streaming manner and plays back the moving image, the moving image transmitting program 21 performs the process of conveying the information about the delivered moving image contents to the user information 1.

The moving image receiving and playing back program 11 provides the function corresponding with the moving image transmitting program 21. The program 11 is run under the control of the OS 13 and the central processing unit 14 and basically performs the following process in concert with the remote-operating program 12.

When receiving a moving image file stored in the data storing unit 28 from the host computer 2 and playing back the moving image from the file, the program 11 is executed to determine a moving image display location on the remote operation view on the basis of the information about a location and a size of the moving image conveyed from the host computer 2, perform a proper decoding process with respect to the compressed moving image data received from the host computer 2, and then perform a playback and display process for keeping the display speed of the moving image stable.

When receiving the moving image delivered by the moving image delivering server 4 in a streaming manner and playing back the moving image, the program 11 is executed to receive the compressed moving image data from the moving image delivering server 4 on the basis of the information about the moving image contents conveyed from the host computer 2, performs a proper decoding process with respect to the compressed moving image data, and then performs a playback and display process for keeping the display speed of the moving image stable.

In this embodiment, since the moving image is played back in the user computer 1, the moving image display is not adversely influenced by the variation of the traffics and the fluctuation of the bandwidth of the network, has no missing image, and enables to keep the intentional display speed.

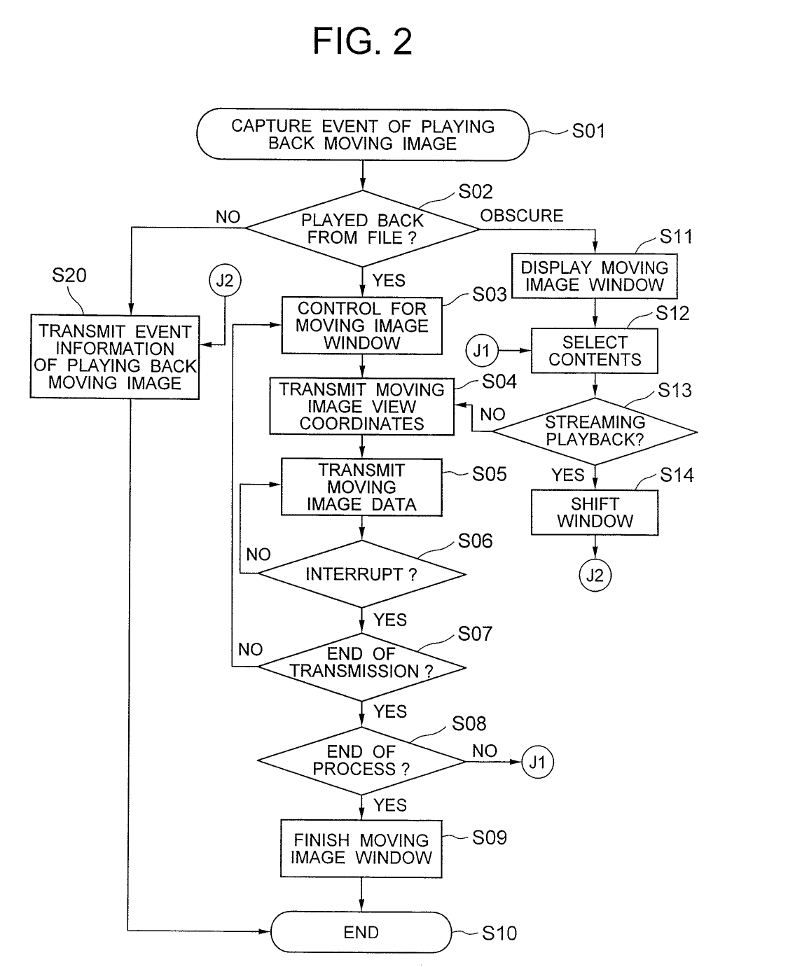

FIG. 2 is a flowchart showing a processing flow of a moving image playback event to be executed in the first embodiment. The moving image displaying method of this embodiment realizes the process shown in FIG. 2 by executing the moving image transmitting program 21 at a time of a moving image playback event such as a receipt of a command for playing back the moving image on the host computer and a start of an application program related with a moving image file and moving image contents.

In the step S01 of capturing the moving image playback event, the remote-operated program 22 is executed to pass the control information for the remote operation to the OS 23. Afterwards, of the events such as the operating response of the OS 23 and the executing response of the application program, the event information about the moving image playback is captured. There are several kinds of moving image playback events to be operated by the operator, the representative ones of which will be described below.

(1) In a case that an operator selects a moving image program from a program list and executes the selected program, the operator selects a name of the program with a mouse pointer and inputs a command for indicating the execution of the program with a mouse button. By capturing the operation, the event information is obtained.

(2) In a case that the operator selects an object to be played back from a list of file names and contents names and executes the object, like the foregoing item (1), the operator selects the name of a target file or target contents and indicates the playback of the selected file or contents with a keyboard and mouse. By capturing the operation, the event information is obtained.

(3) In a case that the operator enters a file name or a contents name and executes the inputted one(s), the operator inputs the name of the file or the contents to be played back with a keyboard and mouse and selects a playback button on an operation view, for example, for indicating the playback of the selected file or contents. Hence, the event information is obtained from the series of operations.

(4) In a case that the contents received through the Internet are related with the moving image application, the OS 23 issues the start command for the application program. Hence, by capturing the command, the event information is obtained.

What is required for the contents of the event information is the name of the object to be played back and the name of the relevant application. The name of the object is obtained by referring to the URI (Uniform Resource Identifier) or the URL (Uniform Resource Locator) and the protocol information such as RTSP (Real Time Streaming Protocol) to be used in requesting the contents is obtained as well.

In this embodiment, the moving image transmitting program 21 is set to the application related with the playback of the moving image, and the control of starting another moving image application program directly from the OS 23 is inhibited in the step S01 of capturing the moving image playback event. For example, in a case that another moving image application program is required for decoding, the control is executed so that the required program is started from the moving image transmitting program 21.

In a step S02, it is determined if the moving image is played back from the moving image file stored in the data storing unit 28 or played back from the moving image data obtained from another moving image delivering server 4 or the like specified by the URI or the like by analyzing the captured event information.

If the moving image is played back from the moving image file, the process goes to a next step S03. If the moving image is played back from the moving image data obtained from another server, that is, the moving image is played back in a streaming manner, the process is branched to the step S20. Herein, if the object to be played back is not specified and the moving image program is directly executed, the determined result is obscure, so that the process is branched to the step S11.

If the moving image is played back from the moving image file, the moving image window is opened on the screen of the display (S03), and the information about the moving image display, such as the location in the window of the moving image on the screen and the size of the moving image, is transmitted as the coordinate data of the display screen to the user computer 1 (S04). Afterwards, the moving image data transmitting process (S05) is continued until an occurrence of interrupt (S06) given by the input operation or an end of transmission (S07).

If the operator of the user computer 1 operates the keyboard and mouse 19 and an interrupt given by the input operation takes place, in a determining step S07, it is determined whether or not it is the end of transmission given by clicking the stop button annexed to the moving image window. If it is, it is determined whether or not the moving image playback process is to be ended in the proceeding step S08.

If it is determined that it is not the end of transmission in the step S07, it is determined that the interrupt concerns with the change of the location or the size of the moving image window or the change of the playback mode such as fast forward, and the process goes back to the step S03, in which the process is restarted from the window control stage.

If it is determined that it is not the end of processing in the step S08, the process jumps to the contents selection step S12. On the other hand, if it is determined that it is the end of processing, the moving image window is closed (S09) and then the moving image playback event is ended (S10).

If it is determined that the determined result is obscure in the step S02, the moving image window on the display screen is opened (S11), and then in the next step S12 the contents selected by the input operation are obtained and the branching determination is executed (S13).

In the step S13, like the step S02, it is determined if the moving image data is obtained from the moving image delivering server 4 or the like and played back in a streaming manner or the moving image file stored in the computer itself is played back. If it is not played back in a streaming manner, that is, the moving image file is played back, the process jumps to the step S04. If it is played back in a streaming manner, in the window shifting process S14, the control of the moving image window is shifted to the user computer 1, and the process jumps to a step S20. In the step S14, the window shifting data, such as the location (start point and horizontal and vertical sizes) of the window displayed on the host computer 2, is transmitted to the user computer 1. In addition, the window shifting data may include the additional data such as a button location.

If the moving image data is obtained from another server and then is played back in the step S02 and the it is determined that the moving image is played back in a streaming manner in the step S13, in the step S20, the moving image playback event information containing the URI information of the object to be played back is transmitted to the user computer 1.

The subsequent moving image playback process is mainly executed in the user computer 1. The moving image playback event is finished upon the end notice sent from the user computer 1 (S10).

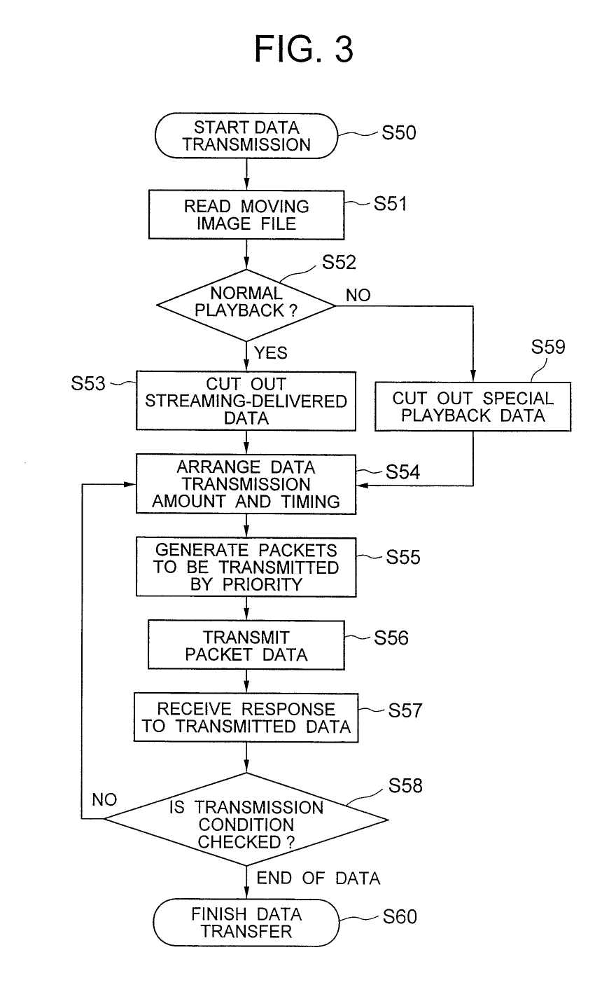

FIG. 3 is a flowchart showing a detailed process of the moving image data transmission (S05) included in the moving image playback event of the first embodiment shown in FIG. 2.

In the moving image display according to this embodiment, in the case of playing back the moving image data stored in the host computer 2, the process shown in FIG. 3 is executed so that the moving image data is transmitted from the host computer 2 to the user computer 1.

When the data transmission is started (S50), in a first step S51, the moving image file data is sequentially read out of the data storing unit 28 into a buffer area prepared by the moving image transmitting program 21.

If the size of the moving image file is smaller than a capacity of the buffer area, after the reading process is finished, the process goes to a next step S52, in which it is determined if the moving image is played back at a normal mode or a special mode like fast forward. If the size of the moving image file is so large that it is not completely read into the buffer area, the following process is carried out as the moving image file is being sequentially read into the buffer area.

If the playback at normal mode is determined, the data delivered in a streaming manner is cut out of the data being read into the buffer area (S53) and the cut data is shaped as the suitable packets for transmitting the moving image as arranging the transmission data amount and the transmission timing (S54). In the priority transmission packet generation (S55), two priority controls are executed. That is, (a) the process of the suitable packets for transmitting the moving image included in the screen data to be outputted to the user computer 1 is carried out on a priority base, and (b) the suitable packets for transmitting the moving image are set if the priority may be specified on the network 3.

In succession, the packet data is transmitted to the user computer 1 through the communication control unit 25 (S56). Then, the response to the data transmission is received (S57) and it is checked if the transmitting timing is proper (S58).

If the moving image is played back at a normal mode in the step S52, that is, it is played back at a special mode, the data for special playback is cut out of the data read into the buffer area (S59). Then, the process goes to the arrangement of transmission data amount and transmission timing S54.

Though not clearly shown in FIG. 3, if the moving image is played back at a special mode like fast forward, in the step S51, the look-ahead reading of the moving image file is executed in the step S51. Further, if the moving image is played back at a special mode like a back feed, the contents and the timings of the moving image file reading S51 and the special data cutting S59 are changed depending upon whether or not the moving image data to be back-fed is left in the buffer area and whether or not the moving image frame data is left in the user computer 1. In particular, if the moving image frame data is left in the user computer 1, a back-feed command is transmitted in place of cutting out the moving image data. This is effective in reducing the transmission data amount.

In the step S58, in addition to the check for the transmission timing, the transmission conditions such as a remaining amount of priority packets waiting for being transmitted and a data amount to be transmitted per unit time are checked on the state of the user computer 1 and the state of the communication control unit 25. If all the data to be transmitted have been already transmitted, the data transmission is finished (S60). If the data to be transmitted is left, the data is being transmitted according to the checked transmission conditions.

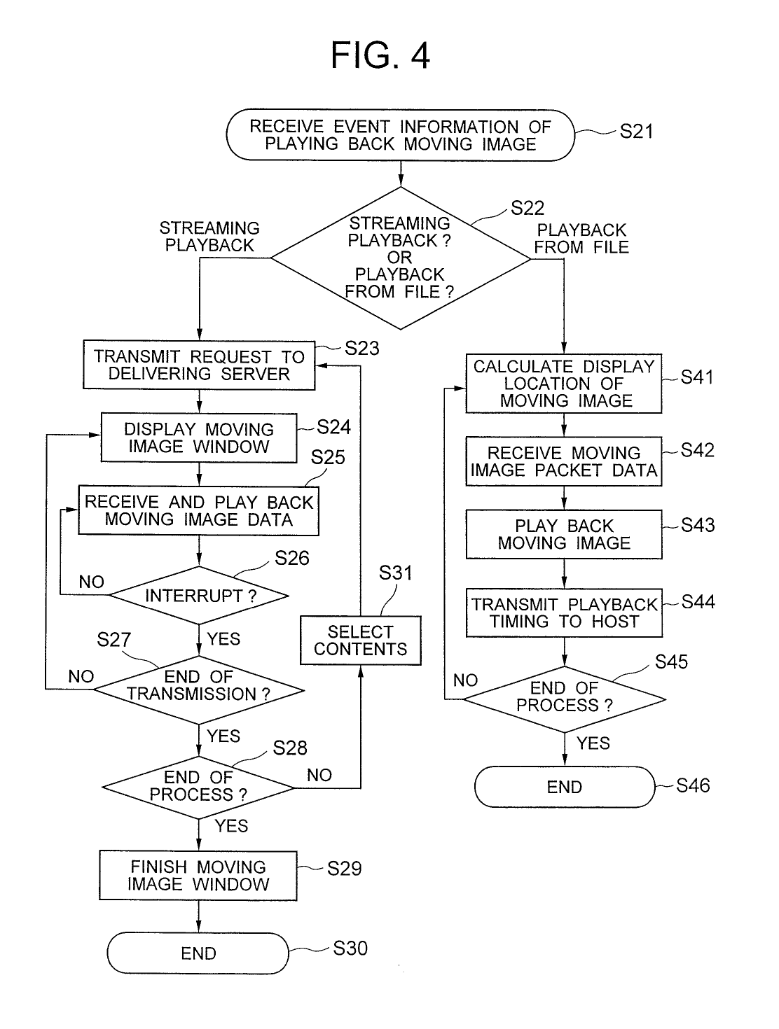

FIG. 4 is a flowchart showing a flow of the moving image data receiving, playing back and displaying process included in the first embodiment. In the user computer 1, the process shown in FIG. 4 is executed in correspondence to the processes of the host computer 2 (see FIGS. 2 and 3).

In the process S21 for receiving the moving image playback event information, the determination in the next step S22 is executed at a time of receiving the moving image playback event information transmitted from the host computer 2 in the step S20 of FIG. 2, the window shifting data transmitted from the host computer 2 in the step S14 of FIG. 2, or the moving image screen coordinate data.

If the moving image playback event information or the window shifting data is received, it means that the moving image data is obtained from another server and is played back in a streaming manner. Hence, the process is branched to a step S23. If the window shifting data is received, the subsequent moving image playback event information is received and then the process goes to a next step. If the moving image screen coordinate data is received, it means that the moving image file is played back. Hence, the process is branched to the step S41.

If the moving image data is played back in a streaming manner in the step S22, the user computer mainly performs the following process for playing back the moving image. At first, the request for obtaining the moving image data is transmitted to the moving image delivering server 4 or the like on the basis of the moving image playback event information (S23) and then the moving image window is displayed on the screen of the display 18 (S24).

At that time, if the window shifting data has been already received, the display location of the moving image window is determined on the basis of the already received data. If not, the display location is determined by referring to the information such as the user's settings and the previous display history.

The request for obtaining the moving image data includes a name of a target object to be played back, specified by the URI or URL and a name of a protocol such as the RTSP used when receiving the data. Further, if personal data such as a user number and a password are required for authorizing the user and performing the accounting, a pop-up screen is displayed on the remote operation view so that an operator may input the data. The operator's inputted information is transmitted to the moving image delivering server 4 or the like.

When the receipt of the moving image data from another server is started, the moving image data receiving and playing back process S25 is continued until an occurrence of an interrupt given by an input operation or the like (S26) or an end of transmission (S27). The playback moving image is displayed at a given location of the moving image window.

If the interrupt given by the input operation takes place (yes in the step S26), in the determining step S27, it is determined whether or not it is the end of transmission by clicking the stop button annexed to the moving image window. If it is the end of transmission, in the next step S28, it is determined whether or not the playback of the moving image is finished.

If it is not the end of transmission in the step S27, it is determined that the interrupt concerns with the change of a location or a size of the moving image window or the change of the playback mode like the fast forward. Then, the process goes back to the step S24, in which the process is restarted from the control for displaying the moving image window.

If it is determined in the step S28 that it is not the end of the process for playing back the moving image, the process is branched to the contents selecting step S31. Then, waiting for the moving image data to be newly specified by the input operation, the request for obtaining the moving image data is transmitted to the moving image delivering server 4 or the like in response to the newly specified moving image data (S23). If it is determined in the step S28 that it is the end of the process for playing back the moving image, the moving image window is closed (S29), and then the process for the moving image playback event is finished (S30). At this time, the end of the process is notified to the host computer 2.

If it is determined in the step S22 that the moving image is played back from the image data file, the moving image screen location is calculated on the received moving image screen coordinate data (S41). In succession, the moving packet data is received from the host computer 2 (S42). In the moving image playback step S43, the received moving image packet data is played back and then is displayed at the moving image screen location calculated in the step S41. In a step S44, the processing time and the state of the buffer area or the like is estimated and then the response of the receiving and playing back timing is transmitted to the host computer 2. This process is not limited to the continuous process shown in FIG. 4. It may be executed in parallel to the processes of the steps S41 to S43.

After the foregoing series of processes are continued until the end of the process (S45), if the moving image screen coordinate data is received when the moving image packet data is received (S42), the process goes back to the steps S41 from which the process is repeated. Further, if the special playback command is received when receiving the moving image packet data (S42), the special playback is executed.

When the process is finished after all the required have been received, the process for receiving, playing back and displaying the moving image data is finished (S46).

According to the foregoing embodiment, the host computer 2 and the user computer 1 that remotely operates the host computer 2 are worked in concert for displaying the moving image. Hence, this embodiment has the following advantages in comparison with the prior art.

First, the user computer 1 located on the operator's side enables to decode the moving image data compressive-encoded according to the standard moving image compression algorithm. Hence, the control for the moving image playback and display is made easier, so that the stable processing result may be obtained. Moreover, this embodiment is effective in reducing the computation to be executed for transmitting the remote operating screen and the adverse influence of the delay and fluctuation occurring in the networking process, so that the reliability may be improved.

Second, unlike the prior art, this embodiment does not need to temporarily decode the data and then encode the data in the host computer 2 before transmitting the data. This is quite efficient. The process may be distributed to the two computers concerned with the remote operation, so that the using efficiency and the processing efficiency of the computer resources may be improved.

Third, this embodiment has a capability of causing the user computer 1 located on the operator's side to receive and playback the moving image delivered from another sever in a streaming manner without through the host computer 2. This is highly functional. The same mechanism holds true to playback of the moving image file depending upon the host computer 2. Hence, this is also practically functional.

In addition, the description about the details of the interrupts given by various input operations and the measures against various faults is left out in the processing flow of the first embodiment.

Further, when loading the moving image transmitting program 21 and the moving image receiving and playing back program 11, it is possible to make them faster and more available in addition to the parallel processing and the backup processing.

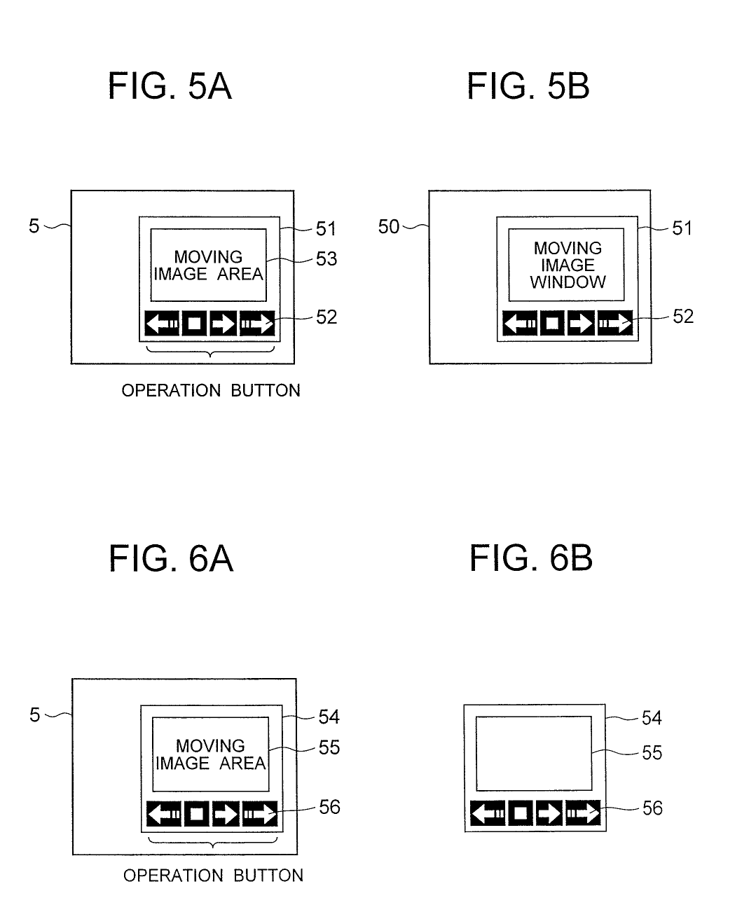

FIGS. 5A and 5B illustrate the screen output of the host computer appearing in the first embodiment. If the moving image is played back from the moving image file in the first embodiment, the moving image is displayed according to the procedure shown in FIGS. 5A and 5B.

FIG. 5A shows one example of a display screen of the user computer 1. When the moving image is played back by the remote operation, on the screen 5 of the display 18, for example, the moving image window 51 transmitted from the host computer 2 is displayed.

In the moving image window 51, for example, an operation button 52 and a moving image area 53 are displayed. In the moving image area 53, the user computer 1 overlaps the moving image played back by itself with the moving image window 51 sent from the host computer 2 and displays the overlapped image.

FIG. 5B shows an example of the output view of the host computer corresponding with the screen view of FIG. 5A. In addition, the host computer 2 may provide no display unit. If the display unit is provided, the host computer 2 does not necessarily display this output view on the display unit.

When playing back the moving image file stored in the data storing unit 28, the host computer 2 creates the output data of the remote operating screen 50 on which the moving image window 51 is opened, compressive-encode the output view data into a predetermined type of output view data, and then send the compressed data to the user computer 1.

An operation button 52 and the like used for the special playback are provided in the moving image window 51. As watching the moving image overlapped with the view of FIG. 5A corresponding with this output view of the host computer, the operator of the user computer 1 clicks the operation button 52 with a mouse or the like and transmits the control information to the host computer for performing the special playback such as the fast forward or the back feed.

FIGS. 6A and 6B illustrate the output views for playing back the moving image according to the first embodiment of the invention. In the first embodiment, if the moving image data is played back as the data is being received from another server, the moving image is displayed according to the procedure shown in FIGS. 6A and 6B.

FIG. 6A shows an example of the display screen of the user computer 1. When playing back the moving image data as receiving the data from another server, on the screen 5 of the display 18, for example, the moving image window 54 sent from the host computer 2 is displayed as shown.

The moving image window 54 includes an operation button 56 and a moving image area 55 used for the special playback, for example. This moving image window 54 is apparently the same as the moving image window 51 shown in FIG. 5B. For clarifying the difference of the playback method, the layout of the view may be arranged.

FIG. 6B shows an example of the output view for playing back the moving image, which corresponds with the view of FIG. 6A. For example, when the streaming playback of the moving image is indicated by the remote operation, the moving image playback event information is transmitted from the host computer 2 to the user computer 1.

The user computer 1 prepares the receipt and playback of the moving image data based on the event information and generates the moving image window 54 for displaying the moving image. In the moving image window 54 are included a moving image area 55 for displaying the playback moving image, an operation button 56 for the special playback, and the like. The output view for playing back the moving image, generated as described above, is overlapped with the remote operation view sent from the host computer 2 and then the overlapped view is displayed.

As watching the display view, the operator of the user computer 1 clicks the operation button 56 with a mouse or the like, for performing the special playback such as the fast forward or the back feed in the user computer 1.

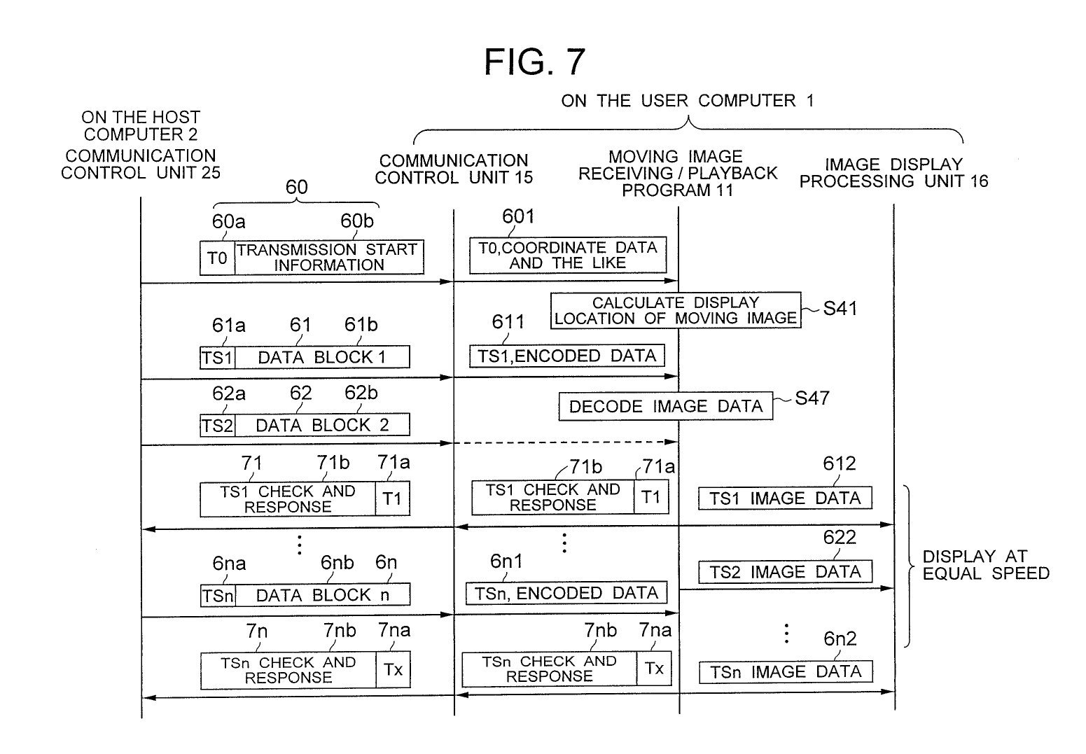

FIG. 7 shows a transfer sequence of the moving image processing executed in the first embodiment. In the first embodiment, when the host computer 2 transmits the moving image data for playing back the moving image from the moving image file, the communication control unit 25 of the host computer 2 transmits the data packets 60, 61, . . . , 6n to the communication control unit 15 of the user computer 1. In the user computer 1, the data contents 601, 611, . . . , 6n1 are processed to be the image data 612, . . . , 6n2 by the moving image receiving and playing back program 11. The image data 612, . . . , 6n2 reach the image display processing unit 16.

The data packet 60 includes as the data content 601a time information 60a for indicating a start time T0 of the processing to be executed in the host computer 2 and a transmission start information 60b, coordinate data about the moving image display that indicates the location on the moving image window and the size of the moving image, and the other information. The data content 601 is transmitted to the moving image receiving and playback program 11 of the user computer 1 (on the receiving side).

The moving image receiving and playback program 11 analyzes the data content 601 and performs the process of calculating the location of the view for displaying the moving image on the basis of the moving image screen coordinate data.

The data packet 61 includes as data contents 611a data block 1 (61b) of the compressive-encoded data cut out of the image file to a proper size and a time stamp TS1 (61a) that indicates the playback timing of the image data. The data contents 611 are transmitted to the moving image receiving and playing back program 11 loaded in the user computer 1.

The program 11 is executed to temporarily save the encoded data received by the user computer 1 in a prepared buffer area and to perform the decoding of the image data as properly arranging the data amount to be temporarily saved. Later, about the encoded data of the data packets 62, . . . , 6n, the decoding playback of the image is repeated in sequence.

The program 11 is executed to cause the user computer 1 to transmit to the image display unit 16 the moving image data played back by the decoding as the image data 612 accompanied with the playback time stamp TS1 as well as send back to the host computer 2 (on the transmitting side) a TS1 check response (71b) with the processing time T1 (71a).

The TS1 check response (71b) may contain the information that indicates the processing state of the user computer 1. This information is conveyed as the data packet 71 from the communication control unit 15 of the user computer 1 to the communication control unit 25 of the host computer 2.

Later, the program 11 is further executed to arrange the display timing so that the playback image data of each playback time stamp TS1, TS2, . . . , TSn may be displayed on the display 18 at an equal speed.

Though not clearly shown, the check response packets are sequentially conveyed according to the playback display, and the process is repeated until the data packet 7n corresponding with the received last data packet 6n.

The communication control unit 25 of the host computer 2 grasps the progressing state of the playing back and displaying process on the receiving side computer on the basis of the processing times T1 (71a), . . . , Tx (7na) given back from the user computer 1 and then checks if the transmission timing of each data packet is fitted to the display timing of the user computer 1.

The checked result is reflected on the transmitting amount and the transmitting timing of the image data to be sent next. For example, if the playing back and displaying process on the receiving side is delayed, the communication control unit 25 of the host computer 2 operates to make the transmission timing faster or reduce the transmission data amount for reducing the processing load burdened to the receiving side.

Moreover, if the processing capability of the receiving side is large enough to process the received data, the host computer 2 enables to make the processing speed faster and increase the amount of data to be cut out of the moving image file for advancing the data processing further. This function causes all the image data on the receiving side to be displayed at an equal speed by effectively using the buffer area of the program 11.

The sequence of FIG. 7 illustrates the exemplary mechanism of replying the check response for each coming data block. Instead, according to the band or the communicating state of the network 3, it is possible to thin out the interval between the check responses or, conversely, give back the same kind of check response when receiving the data or temporarily saving the data in the buffer area for the purpose of controlling the communication between the user computer 1 and the host computer 2 more exactly.

In the first embodiment, the user computer 1 that remotely operates the host computer 2 is worked in concert with the host computer 2 to be remotely operated, for displaying the moving image. Hence, no image is dropped on the display screen of the user computer 1 and the moving image is displayed at an intentional speed.

In particular, when the moving data is transmitted from the host computer 2 (on the transmitting side) to the user computer 1 (on the receiving side), the receiving and playback process is controlled so that on the receiving side the display speed may be kept constant and on the transmitting side the data transmission may be executed in time for the processing of the receiving side or be made faster if the processing capability of the receiving side is large enough to process more data than the current data being processed. This control makes it possible to realize a stable display of the moving image that is hard to be influenced by the delay or the fluctuation of the network. Moreover, since the moving image display process is distributed to the transmitting side and the receiving side, as another advantage, it is possible to effectively use the computer resources.

In the embodiment arranged so that the moving image delivering server 4 or the like transmits the moving image data, the embodiment may be arranged so that the host computer 2 transmits the request for obtaining the moving image data to the moving image delivering server 4 or the like and the user computer 1 receives the moving image data as a response to the request without through the host computer 2.

This causes the host computer 2 to be correctly recognized by the moving image delivering server 4 in the authorization of a user and the management of a copyright and the accounting of the contents, so that the request for obtaining the moving image may be made smoother.

FIG. 8 shows a block diagram showing a network computer system according to another embodiment of the present invention. In this system, a plurality of computers such as personal computers are coupled with a network 3 composed of the Internet or the like so that one computer may remotely operate another one. For the sake of explanation's convenience, in FIG. 8 are shown one user computer 81 on the operator' side, one host computer 82 to be operated, and one moving image delivering server 4 for delivering the compressed moving image data in a streaming manner.

The user computer 81 includes a memory 10, a central processing unit 14, a communication control unit 15, an image display unit 16, an external I/F processing unit 17, and the like in itself. The user computer 81 further includes a display 18 and a keyboard and mouse 19 as external connectable instruments. Those components cause the information to be conveyed among them through the internal connections such as buses (not shown). This is the same as the user computer 1 according to the first embodiment.

On the memory 10 is loaded an OS 13, which is executed by the central processing unit 14, and a remote operating program 83 provided with the moving image processing function 85 specific to this embodiment, which is the application program to be run on the OS 13.

The host computer 82 includes in itself a memory 20, a central processing unit 24, a communication control unit 25, an image display unit 26, an external I/F processing unit 27, a data storing unit 28 such as a hard disk, and so forth.

Though not shown, like the user computer 1, the display and the keyboard and mouse may be coupled as the external instruments. The arrangement of the internal connections is the same as that of the foregoing computer.

In the memory 20 are stored an OS 23, which is executed by the central processing unit 24, and its application programs such as a remote-operated program 84 provided with a moving image processing function 86 specific to this embodiment, a document processing program 29a and a moving image playback program 88.

The network 3 and the moving image delivering server 4 are the same as those of the first embodiment.

When the host computer 82 is remotely operated by the user computer 81, the remote-operating program 83 and the remote-operated program 84 are executed in concert. When playing back the moving image file and the image delivered in a streaming manner, the moving image processing functions S85 and S86 provided in these programs are executed and joined to the cooperative work of these programs for realizing the moving image display. The summary of the processing functions to be executed by the remote-operating program 83 and the remote-operated program 84 are substantially the same as those of the programs 12 and 22 according to the first embodiment of the present invention.

The foregoing processing causes an operator to input data with a keyboard and mouse, for remotely operating the application program such as the document processing program loaded in the host computer 82.

The operation view of the application program is compressive-encoded to a predetermined type of output view data and then is given back to the user computer 81. The operation view is displayed as the remote operation view on the display 18.

The moving image processing function 86 provides a function of transferring the moving image that is an implementation of the moving image display method according to this embodiment. This function 86 basically realizes the following process as a part of processing function of the remote-operated program 84.

When the host computer 82 executes the moving image playback program 88 at a time of an occurrence of an event such as a moving image playback, a streaming receipt of a moving image or a start of an application related with the moving image contents, the moving image processing function 86 is executed to capture a midway result of the process of the moving image playback program 88 through the OS 23 and to send back the processed data to the user computer 81. In this case, when playing back the moving image file stored in the data storing unit 28, the data of the moving image file read in the moving image playback program 88 is picked up at a proper processing stage and then is sent to the user computer 81. Further, in the case of receiving the moving data delivered from the moving image delivering server 4 in a streaming manner and then playing back the moving image, the moving image data received by the moving image playback program 88 in a streaming manner is picked up at a proper processing stage and then is transferred to the user computer 81.

The moving image processing function 85 realizes the function corresponding with the moving image processing function 86. It basically realizes the following process as a part of the processing function of the remote-operating program 83. When the moving image playback program 88 of the host computer 82 displays the moving image window, the moving image processing function 85 and the moving image processing function 86 are worked in concert for determining the playback and displaying process, based on the window control information and the information about the moving image data to be played back. When the user computer 81 receives the moving image data based on the playback and displaying process from the host computer 82, the moving image processing function 85 realizes the proper decoding and image playback so that the moving image may be displayed on the display 18 at a stable speed.

In this embodiment, the playback and displaying process of the moving image is determined so that the playback of the moving image in the user computer 81 is made easier, and the playback moving image is overlapped with the remote operation view on the display. Hence, no missing part of the image occurs on the screen of the display 18 and the moving image may be smoothly displayed at an originally exact speed.

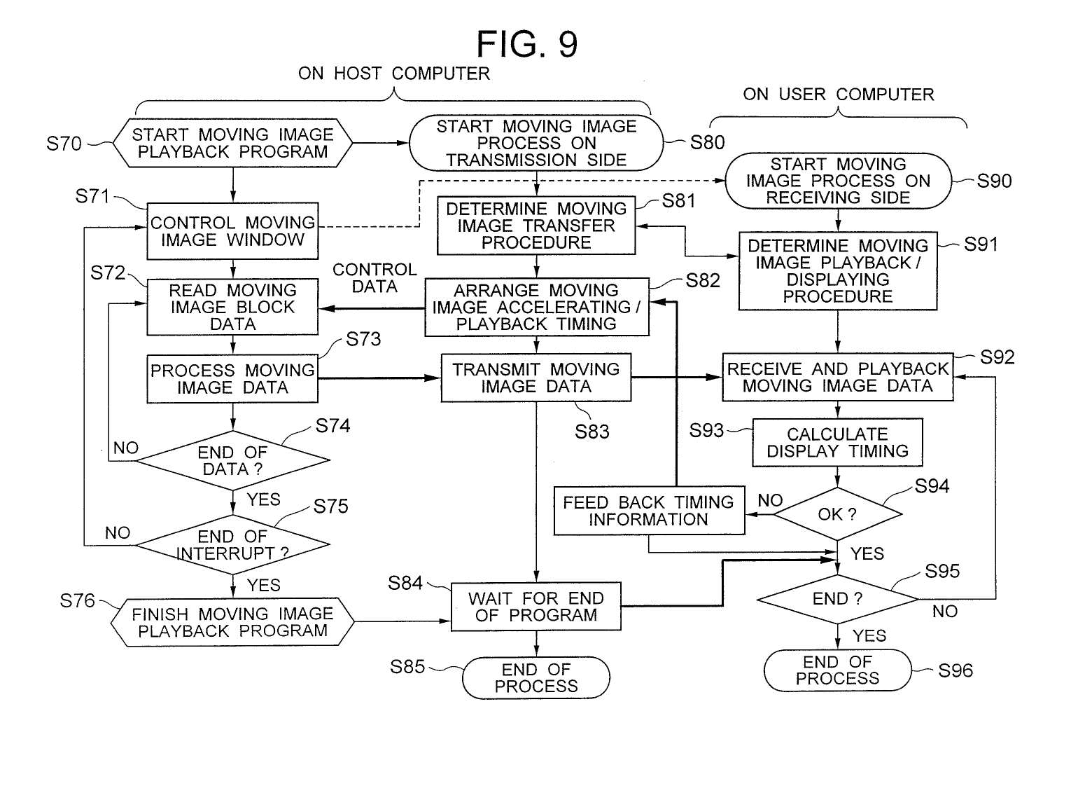

FIG. 9 is a flowchart showing a flow of the moving image display process according to the second embodiment of the invention.

In this embodiment, at the time of start (S70) of the moving image playback program 88 loaded in the host computer 82, the host computer 82 starts the moving image process on the transmitting side (S80). In succession, the user computer 81 starts to process the moving image on the receiving side (S90) and obtains the coordinate data about a display location of a moving image window, derived from the result processed by the moving image window control S71 on the side of the host computer, and the moving image data to be played back.

Further, the moving image processing on the transmitting side may be started at the same time when the moving image processing on the receiving side is started. Or the latter may be started earlier than the former. Further, the data about the playback of the moving image is not necessarily obtained on this timing. The data may be conveyed in advance of the starts of the processings on the receiving and the transmitting sides.

After the start of processing the moving image, in a step S91 of determining the moving image playback and displaying process of the user computer 81, the moving image playback and displaying process is determined on the information about the moving image data and then is transmitted to the host computer 82. Further, the display coordinate of the playback moving image is determined on the coordinate data about the display location of the moving image window.

In a moving image transfer step S81 of the host computer 82, the moving image transmitting process is determined on the moving image playback and displaying process received by the host computer 82 and then is transferred to the user computer 81. At a time, the timing on which the moving image is played back is arranged and the control information is transferred to the moving image playback program 88 or the like (S82).

In a case that the playback of the moving image based on the MPEG (Moving Picture-coding Experts Group) algorithm, for example, is indicated to the host computer 82 by the remote operation, if the moving image processing function 85 of the user computer 81 provides a function of decoding the encoded data of the MPEG image, the decoding function allows the user computer 81 to determine the moving image playback and displaying process (S91).

In this case, the host computer 82 does not decode the MPEG-compressed moving image data but transmits the MPEG data being directly cut to a packet data block of a proper size to the receiving side. This allows the compressed data to be transmitted even if a massive amount of moving image data is played back from the MPEG-compressed data. This thus makes it possible to reduce the data transmission amount and thereby keep the send and receive of the data more stable.

In a case that the user computer 81 does not provide a CODEC (Coder/Decoder) function or program corresponding with the compressive-encoding algorithm, the moving image playback and displaying process is determined so that the decoding process is executed by the moving image playback program 88 or the like of the host computer 82 (S91).

This function causes the host computer 82 to decode the moving image and convert the data into the data of the proper type to the process of the user computer 81. Hence, the user computer 81 may display the moving image data based on various encoding algorithms.

In the moving image block data reading step (S72), based on the control information sent in the step S82, the data of a proper size is read out of the moving image file or the moving image data delivered in a streaming manner and is processed (S73). This processing is repeated until the end of the file or the data (S74).

In a next step S75, an event of an interrupt or the like given by an operator is determined, and the process goes back to the moving image window control (S71) unless the end of the playback program comes. The routine of the steps S71 to S75 is continued until the end of the playback program. The repetition of this routine may be executed by the function originally provided in the moving image playback program 88 or the like. This is easily realized by causing the remote operated program 84 to transfer the control of the remote operation to the moving image playback program 88 or the like.

In the moving image data transmission (S83), the moving image data being processed in the step S73 is picked up at the proper processing stage and then is transmitted to the user computer 81. The pick-up stage follows the predetermined moving image playback and displaying procedure. For example, if the data is decoded in the user computer 81, it is before the decoding process, while if the data is decoded in the host computer 82, it is after the decoding process.

The transmitted data is sequentially processed in the moving data receiving and playback process (S92) of the user computer 81. The playback moving image is displayed on the moving image window located on the remote operating screen. At this time, the display timing is calculated (S93). As a result of the determining process (S94), if the timing is negative, the data is fed back to the process of arranging the moving image playback timing (S82). The routine of the steps S92 to S94 is continued until no received data comes (S95).

If no moving image data to be transmitted is left in the host computer 82, the process enters into the state of waiting for the end of the moving image playback program (S84). If the moving image playback program 88 or the like is finished (S76) when the end is determined (S75) by the remote operation, the state is grasped in the step S84 and then the moving image process of the host computer 82 is finished (S85). As a result, the user computer 81 determines the end of the data receipt in the determining step (S95) and the moving image process on the receiving side is finished (S96).

In the second embodiment, the display timing of the user computer 81 is grasped by the host computer 82 and the playback is controlled so that the image data may be delayed. Hence, the control for the display timing by the user computer 81 is made easier, so that the moving image may be smoothly displayed on the remote operating screen at an originally intentional speed.

The commercially used program may be used for the moving image playback program 88 to be loaded in the host computer 82. No special functional expansion and improvement are not necessary, as long as the executing state of the application can be grasped through the OS 23. Further, as the moving image playback program 88 is used the program that corresponds with not only the standard image coding algorithm like the MPEG coding one but also various kinds of coding algorithms. Hence, the program 88 enables to play back the quasi-moving image like the motion JPEG (Joint Photographic Experts Group) image. Further, the moving image display process is distributed to the transmitting side and the receiving side when it is executed. Hence, as an additional advantage, the computer resources may be effectively used.

In the step S91 of FIG. 9, the moving image playback and displaying procedure is indicated as a processing flow to be determined independently by the user computer 81. Instead, for example, this may be arranged so that a pop-up window is opened on the remote operating screen for prompting the operator to input the data, that is, intentionally select the procedure. This makes it possible for the operator to determine the using state of the user computer 81 and the state of connection with the network 3 and select the proper moving image display method based on the determined result.

Further, in the second embodiment, the displaying process of the host computer 2 is not particularly described. In actual, the host computer 82 provides a capability of displaying image during execution of the remote operation.

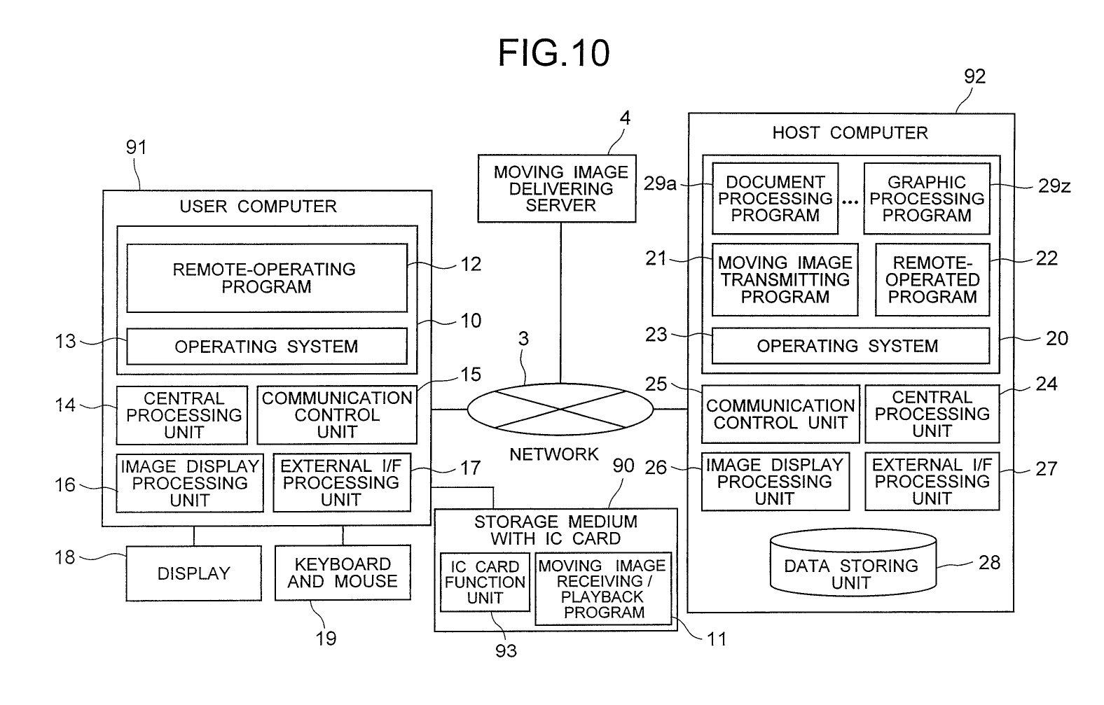

FIG. 10 is a block diagram showing a network computer system according to another embodiment of the present invention. This system is configured to have a plurality of computers like personal computers coupled through a network 3 composed of the Internet or the like so that the remote operation may be executed between the computers.

In FIG. 10, for the sake of explanation's convenience, one user computer 91 on the operator's side and the other host computer 92 to be operated are shown. Further, one moving image delivering server 4 is shown. The server 4 delivers the compressed moving image data or the like in a streaming manner.

The user computer 91 includes in itself a memory 10, a central processing unit 14, a communication control unit 15, an image display processing unit 16, an external I/F processing unit, and so forth and as external connecting instruments a display unit 18, a keyboard and mouse 19, and a storage medium provided with an IC card function 90. Like the user computer 1 of the first embodiment, those components are arranged so that information may be conveyed among them through internal connections such as buses (not shown).

On the memory 10 is stored an OS 13, which is executed by the central processing unit 14, and a remote operating program 12 which is an application program run on the OS 13.

The storage medium provided with an IC card function 90 is coupled with the external I/F unit 17 through the connecting terminal such as a USB (Universal Serial Bus) connector or the like. Thus, it is detachable.

Inside the storage medium provided with an IC card function 90 is included an IC card function unit 93 and a storage area (not shown), in which is stored a moving image receiving and playback program 11. This program 11 is functionally same as the moving image receiving and playback program 11 of the first embodiment.

The host computer 92 includes in itself a memory 20, a central processing unit 24, a communication control unit 25, an image display processing unit 26, an external I/F unit 27, a data storing unit 28 like a hard disk, and so forth.

Though not shown, like the user computer 1, the host computer 92 may further include a display unit and a keyboard and mouse as its external connecting instruments. The arrangement of the internal connections among those components is analogous to that of the foregoing computer.

On the memory 20 is stored an OS 23, which is executed by the central processing unit 24, and the application programs to be run on the OS 23. Those application programs include the moving image transmitting program 21, the remote operated program 22, both of which concern with this embodiment, a document processing program 29a, a graphic processing program 29z, and so forth.

The network 3 and the moving image delivering server 4 are the same as those of the first embodiment.

When remotely operating the host computer 92 through the user computer 91, the remote-operating program 12 and the remote-operated program 22 are worked in concert for processing the data. When playing back the moving image file and the moving image delivered in a streaming manner, the moving image transmitting program 21 loaded in the host computer 92 and the moving image receiving and playback program 11 stored in the storage medium provided with an IC card function 90 are both executed and joined to the cooperative work for realizing the moving image display. The processing functions of these programs are the same as those of the corresponding programs included in the first embodiment.

The foregoing cooperative work of the programs 21 and 11 causes an operator to input data with a keyboard and mouse and to remotely operate the application program such as the document processing program 29a run on the host computer 92 as watching the remote operation view appearing on the screen of the display 18.

The operation view of the application program is compressive-encoded into a predetermined type of output view data and then sent back to the user computer 81. In the user computer 81, it is displayed as the remote operation view on the display 18.

In this embodiment, the moving image receiving and playback program 11 having described with respect to the first embodiment is stored in the storage medium 90 provided with an IC card function and is worked in concert with the moving image transmitting program 21 of the host computer 92, for realizing the moving image transfer and display. This eliminates the necessity of providing the corresponding program with that function in the user computer 91.

The storage medium provided with an IC card function 90 is detachable. Hence, the operator can carry it and connect to another computer (not shown). If the computer does not provide the corresponding function with the moving image receiving and playback program 11, by using the moving image receiving and playback program 11 stored in the storage medium 90, it is possible to smoothly play back and display the moving image on the remote operating screen.

Further, by providing the remote-operating program 12 in preparation for the case that another computer does not provide the corresponding function with the remote-operating program 12, it is also possible to enjoy the merit of spreading the availability to that computer.

An IC card function part 93 provides a function of storing a certificate of an open key authorization or a secret key of the operator. This function makes it possible to easily realize the user authorization when the operator uses the user computer 91 or the network 3. Therefore, even in a case that the operator carries the storage medium provided with an IC card function 90 and connects it to another computer, the operator is correctly authorized, so that the operator can remotely operate the host computer through that computer.

In the third embodiment, the moving image data received from the host computer 2, the moving image delivering server or the like is processed by the moving image receiving and playback program 11 stored in the storage medium 90 provided with an IC card function. Hence, this processing can be completed without having to leave part or all of the received moving image data inside the user computer 91. This makes it possible to prevent fee-based copyrighted moving image contents from being unjustly duplicated, which leads to thorough management of the moving image contents.

The effect specific to the third embodiment has been described above. The other effects about the moving image display method according to this embodiment are the same as those of the first embodiment.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A moving image displaying method to be executed in a network computer system having an operating-side computer and an operated-side computer coupled through a network, the operating-side computer coupling with the operated-side computer for performing input operation to the operated-side computer, and an operation result view appearing on the operated-side computer being displayed on a display unit of the operating-side computer, comprising:
transmitting, by the operated-side computer, control information about playback of a moving image on the operated-side computer to the operating-side computer, based on event information inputted by the operating-side computer;
receiving, by the operating-side computer, moving image data to be playback-controlled by the received control information about playback of the moving image;
playing back, by the operating-side computer, a moving image to be displayed from the received moving image data, based on the control information; and
overlapping, by the operating-side computer, the playback moving image on the operation result view to display the overlapped result on the display unit of the operating-side computer.
